(19) United States
(12) Patent Application Publication
(10) Pub. No.: US 2024/0053062 A1
(43) Pub. Date: Feb. 15, 2024

(54) FASTENING ELEMENT, IN PARTICULAR FOR SOLAR PANELS

(71) Applicant: PAXOS CONSULTING & ENGINEERING GMBH & CO. KG, Langenfeld (DE)

(72) Inventor: Peter HAKENBERG, Solingen (DE)

(21) Appl. No.: 18/549,102

(22) PCT Filed: Mar. 2, 2022
(86) PCT No.: PCT/EP2022/055320

§ 371 Date: Sep. 5, 2023

(30) Foreign Application Priority Data
Mar. 5, 2021 (DE) 10 2021 105 433.8
Dec. 23, 2021 (DE) 10 2021 134 573.1

(51) Int. Cl. F24S 25/617; E04H 17/22; E04H 12/22

(52) U.S. Cl. CPC F24S 25/617; E04H 17/22; E04H 12/2223

(57) ABSTRACT

A fastening element, in particular for solar panels, includes a tubular pole, a load element, and a ground anchor sleeve. The fastening element may include a tubular pole holder for insertion of a free end of the tubular pole. The fastening element further relates to a solar fence, having at least one solar panel which is disposed between two fastening elements and fastened thereto.

### CROSS-REFERENCE TO RELATED APPLICATIONS

This application is a 35 U.S.C. § 371 National Stage patent application of PCT/EP2022/055320, filed on 2 Mar. 2022, which claims the benefit of German patent application 10 2021 105 433.8, filed on 5 Mar. 2021, and which claims the benefit of German patent application 10 2021 134 573.1, filed on 23 Dec. 2021, the disclosures of which are incorporated herein by reference in their entirety.

### TECHNICAL FIELD

The disclosure relates to a fastening element, in particular, for solar panels as well as a solar fence.

### BACKGROUND

Fastening solar panels to fences is often difficult. Due to the feature of being a fence, a so-called solar fence is only fixed one-dimensionally (on a single axis), and due to its vertical installation, it is primarily exposed to high wind loads, which have to be compensated for via the soil. The fastening of the fence elements to ground anchors is also exposed to considerable loads. In order to cope with the high loads, anchoring in the ground is often implemented using concrete foundations that are associated with high investment costs, that seal surfaces, and that can only be removed again at great expense.

The anchoring of the piles, posts or tubular poles of such solar fences within the substrate can also or additionally be carried out via screw foundations or ground screws. Such elements are known from DE 20 2019 102 642 U1 or DE 10 2008 026 215 A1 for example. However, these can also come loose due to the high wind loads, so the fastening is not suitable for permanently fastening solar panels, in particular, not in conjunction with solar fences.

### SUMMARY

The present disclosure proposes a permanent and reliable fastening element for a solar panel, in particular, for solar fences. The fastening element, which is to be fastened within the substrate, should be able to withstand wind loads in particular and not come loose, even over a longer period of operation. The design should be as simple and cost-effective as possible. Furthermore, the object is to create a solar fence that is permanently and reliably fastened within the substrate and is particularly suitable for withstanding wind loads.

This task is achieved by providing a fastening element comprising a tubular pole, a load element, and a ground anchor sleeve and by providing a solar fence comprising at least one solar panel arranged between two fastening elements comprising a tubular pole, a load element, and a ground anchor sleeve, and fastened to the two fastening elements.

Thus, the fastening element according to the disclosure include the main components: A load element, a ground anchor sleeve and a tubular pole An element to be fastened, for example, a solar panel, can be fastened to the tubular pole with the aid of fastening material.

The disclosure is not only suitable as fastening elements for solar fencing or for a solar fence; with the aid of the fastening element according to the disclosure, almost all objects can be securely anchored in the ground. In particular, the disclosure is suitable for fastening large umbrellas, traffic signs, traffic light poles, lanterns and lighting masts (floodlight masts), antenna or radio masts, charging stations (e-mobility), billboards, fences, foundations for containers and prefabricated structures (also prefabricated structures such as greenhouses), noise barriers or wind turbines. The objects mentioned as examples can be easily fastened to the tubular pole of the fastening element according to the disclosure.

The term solar panel refers to elements for the energetic use of solar energy, preferably thermal or electrical (photovoltaic).

The solar fence according to the disclosure comprises at least two corresponding fastening elements and at least one solar panel, which is arranged between these fastening elements and fastened to the fastening elements. Preferably, the solar fence is formed by a plurality of solar panels and fastening elements, which are arranged next to each other either along a straight line or also along an arc. It is also conceivable that the solar panels are arranged at an angle to each other, i.e., in a zigzag shape.

The load element can be made of various suitable materials, in particular, concrete, particularly poured ready-mixed concrete, preferably being steel-reinforced. A high level of mass of the load element increases the stability of the fastening element or the solar fence. Concrete is particularly suitable not only because of its high level of mass, but also because of its low cost and relatively simple production and processing. The steel reinforcement further increases the resistance of the load element. However, as an alternative to concrete production, a plastic with a high level of mass is also suitable for example. In order to enable a quick and easy forming of the load element from a manufacturing mould, correspondingly large draft angles can be provided. The size or height (thickness) and diameter of the load element can be adapted according to the requirements and differ accordingly depending on the application.

The load element is placed on the substrate and anchored, but it is also conceivable that it will be used embedded in the substrate. In this case, after anchoring, the load element is covered with, for example, earth material, which additionally stabilizes the fastening element. The shape and diameter of the load element can be freely selected according to the local conditions, wherein a circular disc is usually suitable.

The diameter of such a pane also essentially depends on the height of the tubular pole and the size of the solar panels to be fastened to it or the expected wind load. When using steel-reinforced concrete, a disc-shaped load element with a diameter of about 0.5 m to 1.5 m, preferably about 1 m, is usually sufficient. The vertical height of the load element can also be selected variably and adapted to local requirements. With the dimensions of the diameter mentioned, a height of the load element of 0.05 m to 0.3 m, in particular about 0.15 cm, has proven to be suitable. In particular, a diameter that corresponds to eight times the height is suitable for a disc-shaped load element made of concrete.

The load element or concrete slab forms the foundation. It comprises a larger recess in the centre for embedding the ground anchor sleeve, as well as preferably one or a plurality of continuous openings or recesses for integration into the ground and later disassembly of the load element. For example, four recesses evenly distributed or arranged across the surface of the load element can be provided, through which wedge-shape structures in the ground or ground spikes or also other ground anchor sleeves are hammered or screwed into the substrate for integration into the ground.

However, the recesses can also be used only to additionally integrate the load element with the substrate. In this case, the recesses do not absorb wedge-shaped structures in the ground or ground spikes, but substrate material pushes into the recesses from below and causes the load element to be better able to withstand lateral thrust, which essentially acts parallel to the substrate. Furthermore, the dead weight of the load element also means that lateral thrust does not lead to lateral evasion or lateral movement of the fastening element.

The fastening element according to the disclosure also takes advantage of the fact that a relatively high wing loading of the load pipe with the objects fastened to it is directed into the load element and into the ground via its support. The contact surface of the load element creates a surface fit in a considerably larger area, which means that forces acting essentially vertically from above can also be safely withstood.

Furthermore, the design of the fastening elements according to the disclosure also results in tilting or bending moments in the tubular pole, which are generated, for example, by wind load on the fastened objects, being also optimally dissipated or distributed. On the one hand, the ground anchor sleeve screwed or hammered into the ground withstands the tilting or bending moments; and on the other hand, the load element is also supported accordingly on the substrate via the contact surface on the substrate so that tension and compressive forces are counteracted.

The side of the load element facing the substrate can also be structured in order to additionally integrate with the substrate. For example, projecting points are conceivable, but also grooves or recesses into which soil can be pressed in. Almost any structure or shape is conceivable that enables better integration with the substrate.

The ground anchor sleeve is formed by a coiled and preferably welded, tapered trapezoidal sheet, on which a flat steel is fixed in a helix, preferably welded. At its end facing away from the substrate, the ground anchor sleeve comprises a tubular pole holder for the tubular pole. In a particularly simple embodiment variant, the holder is formed by an end-side opening of a tubular sleeve longitudinal body of the ground anchor sleeve. The tubular pole is inserted into the longitudinal body of the sleeve or the ground anchor sleeve from above. The interior of the longitudinal body of the sleeve is shaped in such a way that the tubular pole is held in a certain position in the vertical direction and cannot move further into the longitudinal body of the sleeve. This can be achieved by a tapered shape of the longitudinal body, but a cross-sectional narrowing in the course of the longitudinal body of the sleeve is also conceivable.

In the area of its upper end facing away from the substrate, the ground anchor sleeve has means of attack via which the ground anchor sleeve can be contacted and rotated. These can be formed by a cross-section of the longitudinal sleeve body that is non-circular in sections; but alternatively, formations or bars can also be provided, across which a torque can be applied. It is also conceivable to have diametrically opposed openings through which a rod can be passed. A sufficient torque can then be applied to the ground anchor sleeve via the rod, and this can be screwed into the substrate. In the upper area of the ground anchor sleeve, indentations or recesses can also be provided, which initially grasp and guide the inserted tubular pole and secondly can be used to screw the ground anchor sleeve in and out (analogous to a square screw head).

According to the disclosure, the term ground anchor sleeve in a particularly simple embodiment variant of the disclosure can also include an embodiment as a lance, i.e., without a circumferential housing. Depending on the expected wind load and the soil conditions on site, the thread can be dispensed with, in this case, a lance with a smooth outer surface, which is hammered into the ground and holds the fastening element, is sufficient.

The tubular pole forms the extension of the ground anchor sleeve and serves as a set-up and holder for elements to be fastened, preferably solar panels. In principle, the tubular pole can have any desired length and be made of many different materials. For example, it can be made of an aluminium tube or stainless steel, and a resistant plastic is also conceivable. For example, a diameter of 120 mm is sufficient for most applications. Ultimately, however, the tubular pole also does not have to be hollow; it can also be made of solid material. It is also conceivable that the tubular pole could be shaped by a wooden pile.

In a particularly favourable embodiment variant, the components are connected to each other in such a way that the solar panel is held in a moveable manner, which means that it can avoid wind load, so to speak, and the fastening element or the solar fence is not damaged. The necessary degrees of freedom of movement can be ensured by the ground anchor sleeve itself, the connection of the ground anchor sleeve to the tubular pole, by the tubular pole itself and/or by connecting the tubular pole to the solar panel.

The solar panel can therefore be moved by itself and thus directly or by moving the tubular pole, i.e., indirectly.

In a particularly favourable embodiment variant, a plurality of fastening elements according to the disclosure are combined to form a fastening system. For example, a central fastening element, which comprises the tubular pole, can be additionally fastened to the substrate via one or a plurality of external fastening elements. In sections, the outer fastening elements rest on a surface of the central fastening element facing away from the substrate and, like the central fastening element, are fastened within the substrate using appropriate ground anchor sleeves, ground spikes or wedge-shaped structures in the substrate. Thus, the central fastening element is placed in areas between the substrate and the outer fastening elements. Depending on the proportions, for example, there are four external fastening elements that are arranged around the tubular pole and additionally secure the central fastening elements. Theoretically, however, even a single additional external fastening element can be sufficient to adequately fasten the central fastening element.

In a further embodiment variant, the external fastening elements of the favourable fastening system are not arranged in areas on the surface facing away from the substrate but are also arranged adjacent to the central fastening element over the entire surface of the substrate. The central fastening elements and the outer fastening elements preferably touch each other with their lateral, vertically aligned surfaces. Primarily, the external fastening elements in this embodiment variant prevent lateral displacement of the central fastening element. Here, the use of only one or a plurality of adjacent fastening elements is also conceivable, and mixed forms of the two fastening systems described, i.e., with overlying and adjacent fastening elements, are also possible.

In principle, the outer fastening elements can also have tubular poles, they would then not only hold the central fastening elements additionally, but also offer the possibility of fastening other objects.

It has proven to be particularly favourable if the tubular pole can be pivoted towards the load element and thus towards the substrate. For this purpose, a corresponding pivot element is provided in the transition area between the tubular pole and the ground anchor sleeve. In a particularly favourable embodiment variant, an elastomer element is disposed within the tubular pole holder, which surrounds the tubular pole inserted into the tubular pole holder. By compressing the elastomer element, the tubular pole can thus be pivoted by a certain amount towards the load element and thus towards the substrate. Due to the formation and arrangement of the elastomer element in the tubular pole holder, the pivotability of the tubular pole in different directions can be influenced in various ways. For example, it can be possible to pivot the tubular pole more strongly in certain directions, for example transversely to the main extension of the solar tube, than transversely to it, i.e., in the direction of the solar panels located on the tubular pole.

The bearing, which is intended to enable pivotability, can also be disposed elsewhere or even at a plurality of points within the progression of the tubular pole, but it would then have to be designed in a different way accordingly. For example, the tubular pole can have a spiral spring or an elastomer element in sections, which allow the desired movements. Of course, a bearing designed in such a way can also be arranged close to the ground anchor sleeve or the substrate. A pivotability of the tubular pole towards the load element by up to 60°, preferably up to 30°, is particularly favourable.

Preferably, the solar panel fastened to the tubular pole itself is also swivel-mounted. In a particularly preferred embodiment variant, the solar panel is held on the tubular pole by means of a rotary bearing, wherein the rotary bearing is disposed on a vertically extending vertical edge of the solar panel, which runs parallel to the tubular pole in a windless state. With regard to the extension of the vertical edge, the rotary bearing can be disposed approximately in the middle of the vertical edge, but the rotary bearing is particularly preferably placed as high as possible, i.e., as far away as possible from the load element. The rotary bearing allows the solar panel to rotate around the axis of rotation specified by the rotary bearing when subjected to the appropriate wind load.

The rotary bearing can be designed in such a way that the angle of rotation is limited by the rotary bearing itself. For example, a rotary bearing sleeve open in the direction of the solar panel can be provided on the tubular pole, into which a pin projecting from the solar panel extends. Inside the rotary bearing sleeve, an elastomeric bearing is provided into which the pin extends. The pin comprises a non-circular cross-section, preferably an oval cross-section, which is held in a correspondingly shaped holder in the elastomeric bearing. Twisting the pin compresses the elastomer bearing, whereby the rotational movement, for example, caused by the wind load, is opposed with increasing resistance. Instead of the elastomeric bearing, other types of bearings can also be used at this point, which allow a rotational movement of the solar panel and, if necessary, to also delimit it. For example, the use of a torsion spring is conceivable.

In addition, or alternatively, the use of an additional pivot-limiting element is also possible according to the disclosure. For example, the rotary bearing can in principle allow 360° rotation, but this is delimited by a pivot-limiting element disposed above or below the rotary bearing. This can be formed, for example, by a spiral spring, which is fastened with one end to the tubular pole and with the other end to the solar panel, preferably to the vertical edge. This prevents the solar panel from twisting too far. For most applications, it is sufficient if the solar panel can pivot up to 60° towards the tubular pole.

The main components can be designed both individually as well as be interconnected with one another. For example, the ground anchor sleeve and tubular pole can be designed as separate elements or as a single element.

According to the disclosure, the fastening elements can be used to form a solar fence. In this case, two fastening elements have a distance from each other that is adapted to the width of the solar panel to be installed. A solar panel is therefore fastened to a fastening element or a tubular pole with its two vertical edges, i.e., it is located between two tubular poles. A solar fence is usually made up of a plurality of solar panels, each of which is fastened to two tubular poles. The solar fence can extend along a straight line, but of course the solar fences can also be arranged at an angle to each other, for example they can be positioned in a zigzag shape. A plurality of solar panels can also be fastened to a tubular pole.

The fastening element according to the disclosure can be assembled and disassembled, for example, as follows:

For the assembly of the fastening element according to the disclosure, the soil is first drilled/excavated by means of an excavator (auger). The result is an approx. 0.2-0.3 m deep hole with a diameter of approx. 1 m and an approx. 1.5 m deep hole with a diameter of approx. 0.06 m. In the first, larger hole, the load element, preferably executed as a concrete slab, is inserted/pressed in as a foundation.

The ground anchor sleeve is then screwed through the central recess into the second, deeper hole. In the process, the soil compacts due to the wedge-shaped geometry of the ground anchor sleeve and is brought under tension. The areas between the flat steel cut into the earth and solidify the system. It is practically no longer possible to pull out the ground anchor sleeve.

The ground anchor sleeve protects against the dynamic tension-compression-wind load, because the sleeve and the concrete slab can be used to introduce far-reaching forces (or a pair of forces) that withstand the bending moment of the post or tubular pole (caused by wind forces on the fastened element).

The conically tapered ground anchor sleeve presses into the concrete slab so that it absorbs the changing forces free of play.

The concrete slab is then preferably covered with soil so that the smaller recesses also become clogged with soil. In the case of difficult surfaces, additional wedge-shaped structures in the ground/ground spikes can be hammered into the smaller recesses. After installation, the system can be further solidified/compacted and covered with greenery.

The tubular pole is pressed into the ground anchor sleeve. The indentations/recesses on the ground anchor sleeve have a jamming effect.

Then, the solar panel is fastened to the tubular pole.

When erecting a solar fence, a plurality of fastening elements and a plurality of solar panels are installed.

For disassembly, the fastened elements are first detached from the tubular pole(s). The ground anchor sleeve and the concrete slab are exposed (freed from the ground). At the indentations/recesses of the ground anchor sleeve, it can be gripped and unscrewed. To lift out the concrete slab, hooks are inserted into the recesses and the load element is pulled out by means of a crane/excavator. Alternatively, the concrete slab can have eyelets or hooks over which it can be gripped or to which a hoist can be fastened.

The fastening element according to the disclosure is cost-effective, since no ready-mixed concrete is required (only one load element, for example, a concrete slab), quick to install, immediately loadable, environmentally friendly (since little material is used), easy to dismantle and, if necessary, reusable. In particular, it can also be subsequently moved.

Due to the low use of materials and the simple disassembly, the area (agricultural land) can be easily returned to its original state (e.g.: Farmland becomes building land).

### BRIEF DESCRIPTION OF THE DRAWINGS

The disclosure is explained in more detail based on the following figures. These are only to be understood as examples, they are not intended to limit the disclosure to the exemplary embodiments shown. In particular, the figures are not true to scale, they are merely simplified representations of principles. The figures show:

FIGS. 1a to 1f: different views of a fastening element according to the disclosure,

FIGS. 2a to 2e: fastening elements inserted into a substrate,

FIG. 3 a ground anchor sleeve of a fastening element according to the disclosure,

FIG. 4 a first embodiment variant of a tubular pole holder with an elastomer element,

FIG. 5 a second embodiment variant of a tubular pole holder with an elastomer element,

FIGS. 6a, 6b: a fastening system with external fastening elements resting on top in sections, and

FIGS. 7a, 7b: a fastening system with adjacent non-surface-mounted external fastening elements.

### DETAILED DESCRIPTION OF THE DRAWINGS

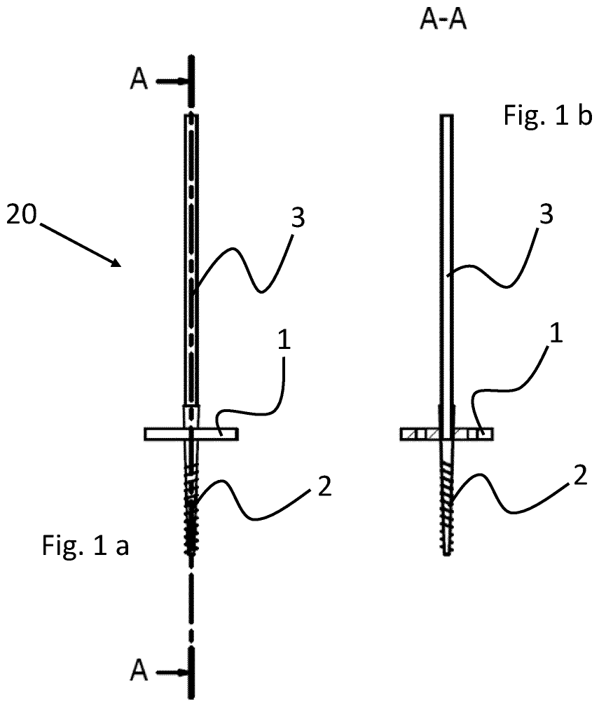

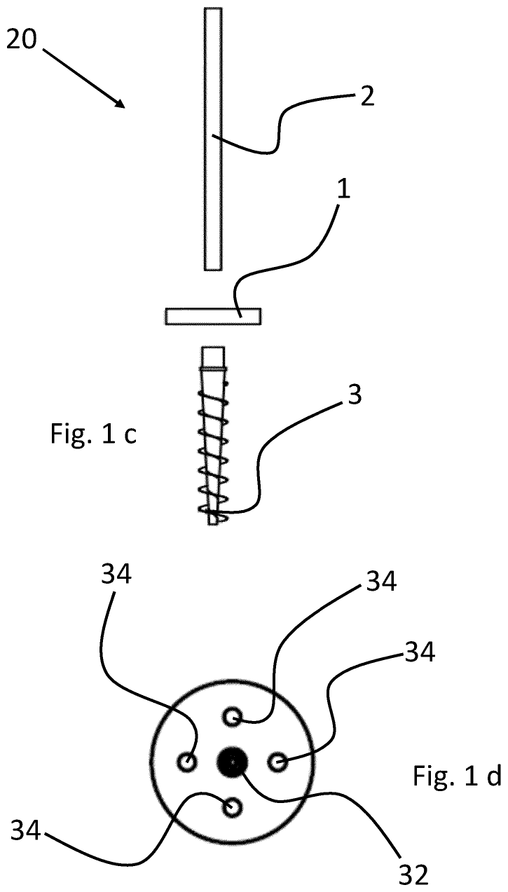

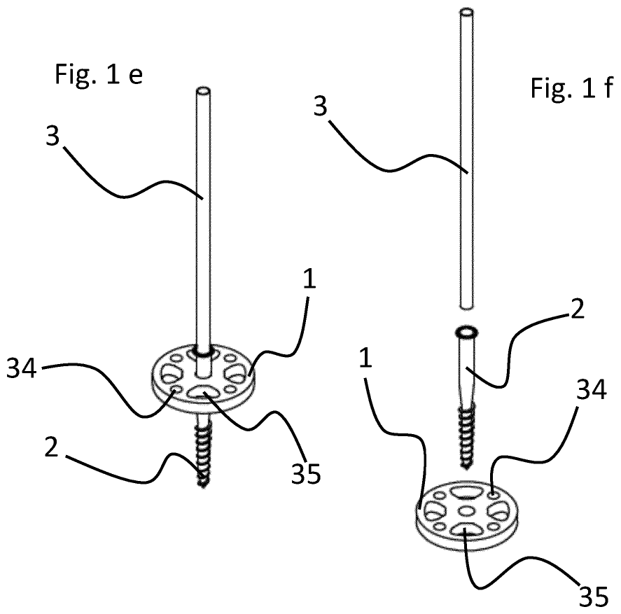

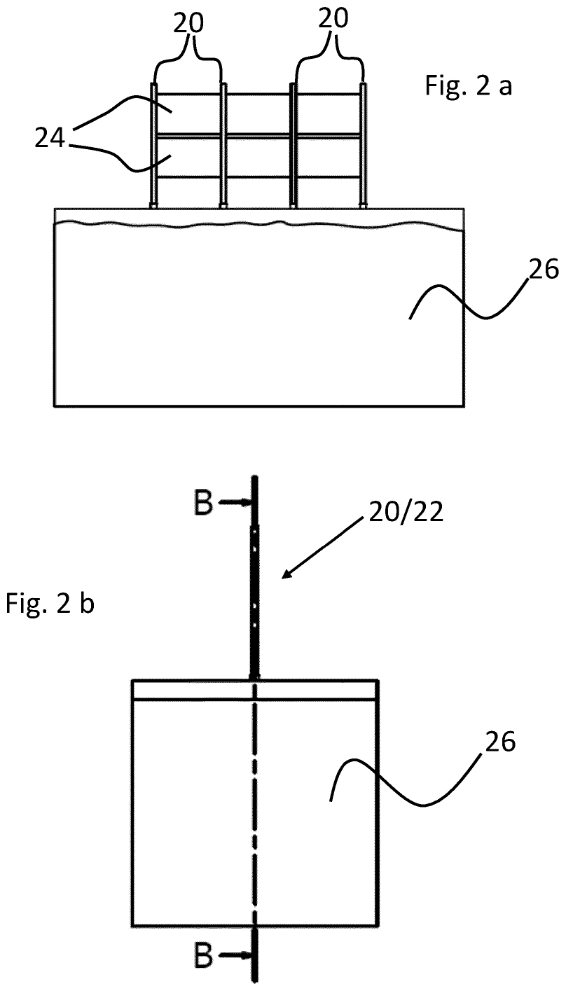

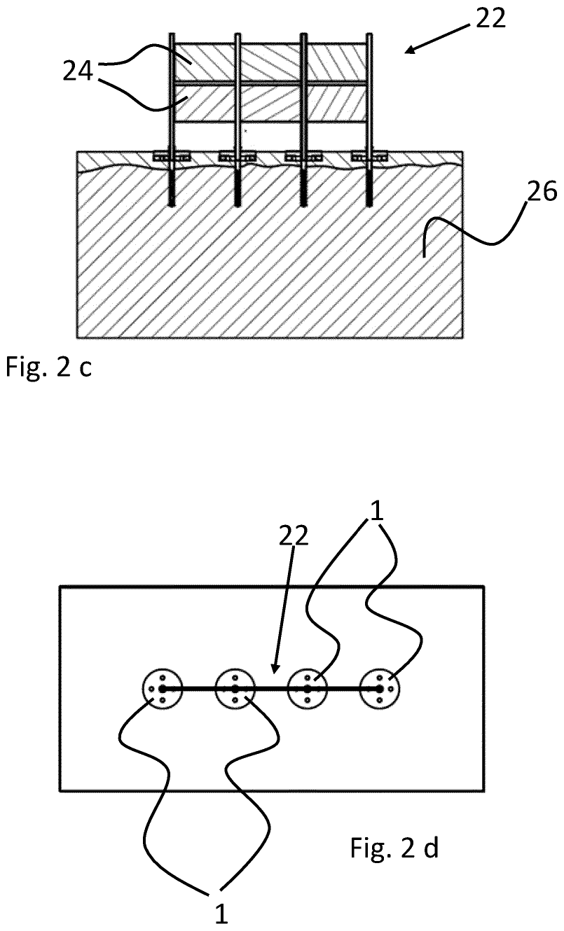

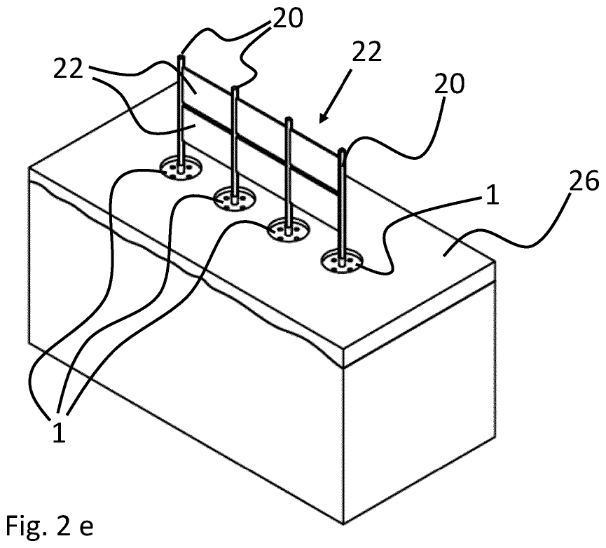

FIG. 1 shows the basic structure of a fastening element 20 according to the disclosure, having a load element 1, a ground anchor sleeve 2 and a tubular pole 3. The fastening element according to the disclosure 20 is particularly suitable for the erection of a solar fence 22, as shown in FIGS. 2 and 7, but any other objects can also be fastened to the substrate by means of the fastening element 20 according to the disclosure. Such a solar fence 22 is formed from at least two fastening elements 20 and a solar panel 24 located between them. FIG. 7 shows as an example only a single solar panel 24 between two fastening elements 20.

A fastening element 20 is inserted into a substrate 26 via the ground anchor sleeve 2 and is firmly anchored in the substrate due to the formation of the ground anchor sleeve 2 in connection with the load element 1. In the exemplary embodiment shown above, the tubular pole 3 and the ground anchor sleeve 2 are made of two pieces and are preferably only connected to each other on site. For this purpose, the ground anchor sleeve 2 has a tubular pole holder 28 into which a free end of the tubular pole 3 can be inserted.

In the exemplary embodiment shown, load element 1 is designed as a circular disc, which is preferably made of steel-reinforced concrete. As can be seen in particular from FIG. 1d, the load element 1 has a central recess 32 through which a free end of the ground anchor sleeve 2 extends when installed. Furthermore, four evenly distributed openings 34 are provided, through which wedge-shaped structures in the ground or ground spikes 52 (cf. FIG. 7) can be driven into the substrate 26 for earth integration. In addition, there are openings or recesses 35, which effectuate integration with the substrate.

The structure of an favourable ground anchor sleeve 2 is particularly evident in FIG. 3. The ground anchor sleeve 2 is formed by a coiled and preferably welded, tapered trapezoidal sheet, which forms a tubular sleeve longitudinal body 40, on which a flat steel 38 is fixed in a helix, preferably welded. The ground anchor sleeve 2 comprises the tubular pole holder 28 for the tubular pole 3 at its end facing away from the substrate, which is formed by an end-side opening of the tubular sleeve longitudinal body 40. The tubular pole 3 is inserted into the tubular pole holder 28 in sections, wherein the conicity delimits the insertion of the tubular pole 3. Furthermore, an indentation 42 is provided, which reduces the diameter inside the tubular pole holder 28 and thus additionally fixes the tubular pole 3.

The tubular pole holder 28 preferably has a non-circular cross-section not shown to accommodate a tool with which the ground anchor sleeve 2 can be screwed into the substrate 26. For example, a square opening in the style of a square key holder is suitable. The non-circular cross-section can preferably be designed and arranged in such a way that a tubular pole 3 with a round cross-section can still be accommodated in the tubular pole holder 28. For example, only a certain length section, preferably adjacent to the opening of the tubular pole holder 28, can be non-round, which then changes into a round cross-section in the direction of the substrate 26.

It has been shown that in average Central European substrate types, the area of the ground anchor sleeve 2 below the load element 1 should have about six times the length of the height D of the load element 1 in order to ensure stable fastening in the substrate 26. For example, the tubular pole holder 28 can have a pick-up depth for the tubular pole 3 that corresponds to three times the height D of the load element 1. The diameter of a circular load element 1 should be approximately eight times the height D of the load element 1.

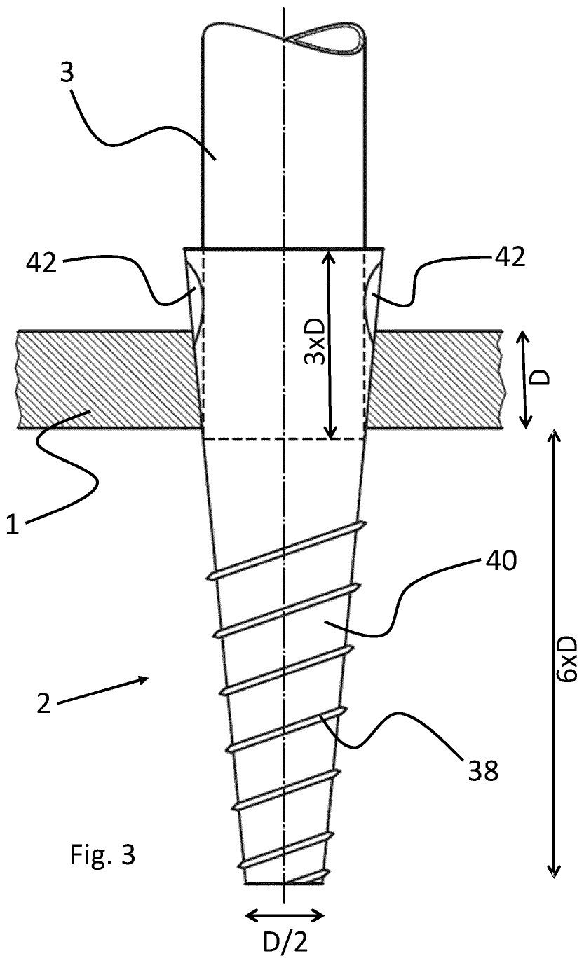

In the transition area between the tubular pole 3 and the ground anchor sleeve 2, a pivot element is provided in the exemplary embodiment shown, which enables the tubular pole 2 to be pivoted. FIGS. 4 and 5 show embodiment variants in which an elastomer element 30 is disposed within the tubular pole holder 28, which surrounds the tubular pole holder 3 inserted into the tubular pole holder 28. In the variant in accordance with FIG. 4, there is pivotability in all directions and this is essentially possible with the same amount of force. Instead of the variant of a structured elastomer element 30 shown in FIG. 4, it is also possible to use an elastomer element 30 made of a consistently solid material. By selecting the elastomer element material, the force opposing the movement can be adjusted.

FIG. 5 shows an embodiment variant in which the usability is only possible along a single axis of motion. For this purpose, the tubular pole holder 28 is not circular but oval. The smallest diameter corresponds approximately to an outer diameter of tubular pole 3. Between an inner wall of the tubular pole holder 28 and the tubular pole 3, elastomer elements 30 are arranged on the two diametrically opposite sides with a larger diameter of the tubular pole 3. Due to this arrangement, a pivotability is only possible in the direction of the two elastomer elements 30 but not transversely to them.

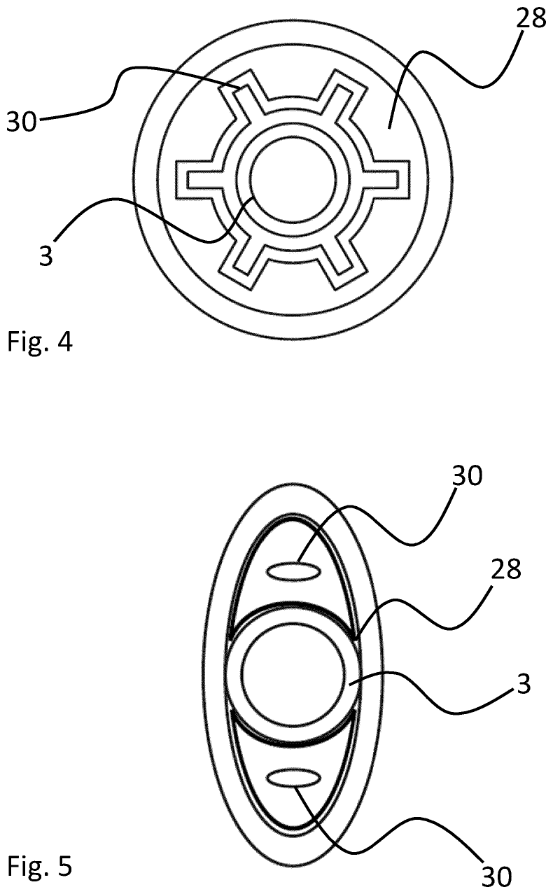

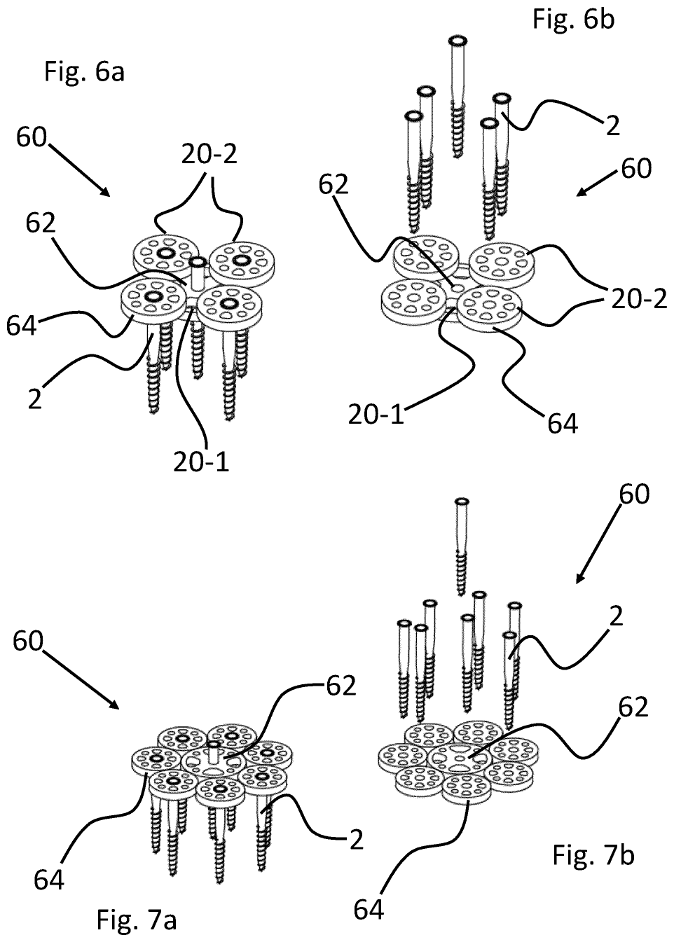

In a particularly favourable embodiment variant, in accordance with FIGS. 6a and 6b, a plurality of fastening elements according to the disclosure 20 are combined to form a fastening system 60. For example, a central fastening element 20-1, which comprises the tubular pole 3, can be additionally fastened to the substrate via one or a plurality of external fastening elements 20-2. The outer fastening elements 20-2 rest in sections on a surface 62 of the central fastening element 20-1 facing away from the substrate and, like the central fastening element 20-1, are fastened within the substrate via corresponding ground anchor sleeves 2, ground spikes 52 or wedge-shaped structures in the substrate. Thus, the central fastening element 20-1 is located in areas between the substrate and the outer fastening elements 20-2.

In a further embodiment variant shown in FIGS. 7a and 7b, the outer fastening elements 20-2 are not arranged in an area on the surface 62 facing away from the substrate but are also arranged adjacent to the central fastening element 20-1 over the entire surface of the substrate. In the exemplary embodiment shown, the central fastening element 20-1 and the outer fastening elements 20-2 touch each other with their lateral, vertically aligned shell surfaces 64. Primarily, the outer fastening elements 20-2 in this embodiment variant prevent lateral displacement of the central fastening element.

The disclosure is not limited to the exemplary embodiment shown, further embodiment variants of the individual elements of the fastening element 20 and/or the solar fence 22 are also possible.

1. A fastening element for solar panels, comprising a tubular pole, a load element and a ground anchor sleeve.

2. The fastening element, according to claim 1, wherein the ground anchor sleeve comprises a tubular pole holder, into which a free end of the mast tube is configured to be inserted.

3. The fastening element, according to claim 1, wherein the load element is disc-shaped and has a central recess through which a free end of the ground anchor sleeve extends when installed.

4. The fastening element according to claim 3, wherein the tubular pole is configured to be moved by a pivot element towards the load element.

5. The fastening element according to claim 4, wherein the pivot element is formed by an elastomer element disposed within the tubular pole holder, which surrounds the tubular pole holder inserted into the tubular pole holder.

6. The fastening system, comprising at least two fastening elements according to claim 1, wherein the fastening elements are configured such that, when fastened, are arranged such that a central fastening element is located below an outer fastening element and is thus arranged between a substrate and the outer fastening element.

7. The fastening system, comprising at least two fastening elements according to claim 1, wherein the fastening elements are configured such that, when fastened, are arranged such that a central fastening element is laterally adjacent to an external fastening element.

8. The fastening system according to claim 7, wherein outer shell surfaces of the two fastening elements touch each other when fastened.

9. The fastening system according to claim 6, wherein a plurality of external fastening elements are provided for each central fastening element.

10. A solar fence comprising at least one solar panel which is arranged between two fastening elements according to claim 1 and fastened to the two fastening elements.
